(19) United States
(12) Patent Application Publication
(10) Pub. No.: US 2014/0297876 A1
(43) Pub. Date: Oct. 2, 2014

(54) METHOD AND APPARATUS FOR INTEGRATING APPLICATIONS AND RELATED COMMUNICATIONS

(71) Applicants: Courtney Aquilina, North Andover, MA (US); Jana Kovacevic, Mountain View, CA (US); Elizabeth Dykstra-Erickson, Helsinki (FI)

(72) Inventors: Courtney Aquilina, North Andover, MA (US); Alan Westbrook, San Jose, CA (US); Jana Kovacevic, Mountain View, CA (US); Elizabeth Dykstra-Erickson, Helsinki (FI)

(73) Assignee: NOKIA CORPORATION, Espoo (FI)

(21) Appl. No.: 13/582,304

(22) PCT Filed: Feb. 16, 2011
(86) PCT No.: PCT/FI2011/050145

§ 371 Date: Feb. 12, 2013

Related U.S. Application Data
(60) Provisional application No. 61/310,529, filed on Mar. 4, 2010.

(51) Int. Cl. H04L 29/08

(52) U.S. Cl. CPC H04L 67/141
USPC 709/227

(57) ABSTRACT

An approach is provided for presenting communications between users. A request to initiate a communication session between a first device and a second device is received. The communication session is associated with content presented by an application. Presentation of a user interface of the application to depict the content is caused, at lead in part. Representation of the communication session as an element of the user interface is caused, at least in part. Manipulation of the element controls the communication session.

### BACKGROUND

Service providers and device manufacturers (e.g., wireless, cellular, etc.) are continually challenged to deliver value and convenience to consumers by, for example, providing compelling network services. These network services can include providing collaborative services, productivity applications, maps, e-mail, social networking services, etc. Many of these services additionally allow for concurrent messaging and/or other related communication functions among the users of the services. For example, online collaboration and presentation tools allow for the sharing of documents and presentations among a group of users or devices, while additionally providing for chatting functionality among the users. However, as the number of chats and the complexity of the shared documents grow, users may often find it difficult to navigate between the main functions of the application (e.g., document sharing, maps, social networking websites, e-mail, etc.) and the functions of the accompanying chat or other communication service, particularly when accessing such services on a device with a limited display area and/or display capabilities (e.g., a handset, smartphone, mobile terminal, etc.). Accordingly, service providers and device manufacturers face significant technical challenges to managing the display, interaction, and user interface of the services while also providing concurrent messaging services.

### SOME EXAMPLE EMBODIMENTS

Therefore, there is a need for an approach for effectively integrating the user interface of an application or service with the user interface of any concurrent communication sessions occurring during use of the application.

According to one embodiment, a method comprises receiving a request to initiate a communication session between a first device and a second device, the communication session associated with content presented by an application. The method also comprises causing, at least in part, presentation of a user interface of the application to depict the content. The method further comprises causing, at least in part, representation of the communication session as an element of the user interface. Manipulation of the element controls the communication session.

According to another embodiment, an apparatus comprising at least one processor, and at least one memory including computer program code, the at least one memory and the computer program code configured to, with the at least one processor, cause, at least in part, the apparatus to receive a request to initiate a communication session between a first device and a second device, the communication session associated with content presented by an application. The apparatus is also causes at least in part, presentation of a user interface of the application to depict the content. The apparatus is further causes, at least in part, representation of the communication session as an element of the user interface. Manipulation of the element controls the communication session.

According to another embodiment, a computer-readable storage medium carrying one or more sequences of one or more instructions which, when executed by one or more processors, cause, at least in part, an apparatus to receive a request to initiate a communication session between a first device and a second device, the communication session associated with content presented by an application. The apparatus is also causes at least in part, presentation of a user interface of the application to depict the content. The apparatus further causes, at least in part, representation of the communication session as an element of the user interface. Manipulation of the element controls the communication session.

According to another embodiment, an apparatus comprises means for receiving a request to initiate a communication session between a first device and a second device, the communication session associated with content presented by an application. The apparatus also comprises means for causing, at least in part, presentation of a user interface of the application to depict the content. The apparatus further comprises means for causing, at least in part, representation of the communication session as an element of the user interface. Manipulation of the element controls the communication session.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

For various example embodiments of the invention, the following is applicable: A method comprising: facilitating a processing of and/or processing: (1) data and/or (2) information and/or (3) at least one signal; the (1) data and/or (2) information and/or (3) at least one signal based at least in part on (or derived at least in part from) any one or any combination of methods (or processes) disclosed in this application as relevant to any embodiment of the invention.

For various example embodiments of the invention, the following is also applicable: A method comprising facilitating access to at least one interface configured to allow access to at least one service, the at least one service configured to perform any one or any combination of network or service provider methods (or processes) disclosed in this application.

For various example embodiments of the invention, the following is also applicable: A method comprising facilitating creating and/or facilitating modifying: (1) at least one device user interface element and/or (2) at least one device user interface functionality; the (1) at least one device user interface element and/or (2) at least one device user interface functionality based at least in part on the following: data and/or information resulting from one or any combination of methods or processes disclosed in this application as relevant to any embodiment of the invention and/or at least one signal resulting from one or any combination of methods (or processes) disclosed in this application as relevant to any embodiment of the invention.

For various example embodiments of the invention, the following is also applicable: A method comprising creating and/or modifying: (1) at least one device user interface element and/or (2) at least one device user interface functionality; the (1) at least one device user interface element and/or (2) at least one device user interface functionality based at least in part on the following: data and/or information resulting from one or any combination of methods (or processes) disclosed in this application as relevant to any embodiment of the invention and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

### BRIEF DESCRIPTION OF THE DRAWINGS

The embodiments of the invention are illustrated by way of example, and not by way of limitation, in the figures of the accompanying drawings:

FIG. 1 is a diagram of a system capable of integrating applications and related communications, according to one embodiment;

FIG. 2 is a diagram of the components of user equipment configured to integrate applications and related communications, according to one embodiment;

FIG. 3 is a flowchart of a process for integrating applications and related communications, according to one embodiment;

FIGS. 4A-7C are diagrams of user interfaces utilized in the processes of FIG. 3, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for integrating applications and related communications are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

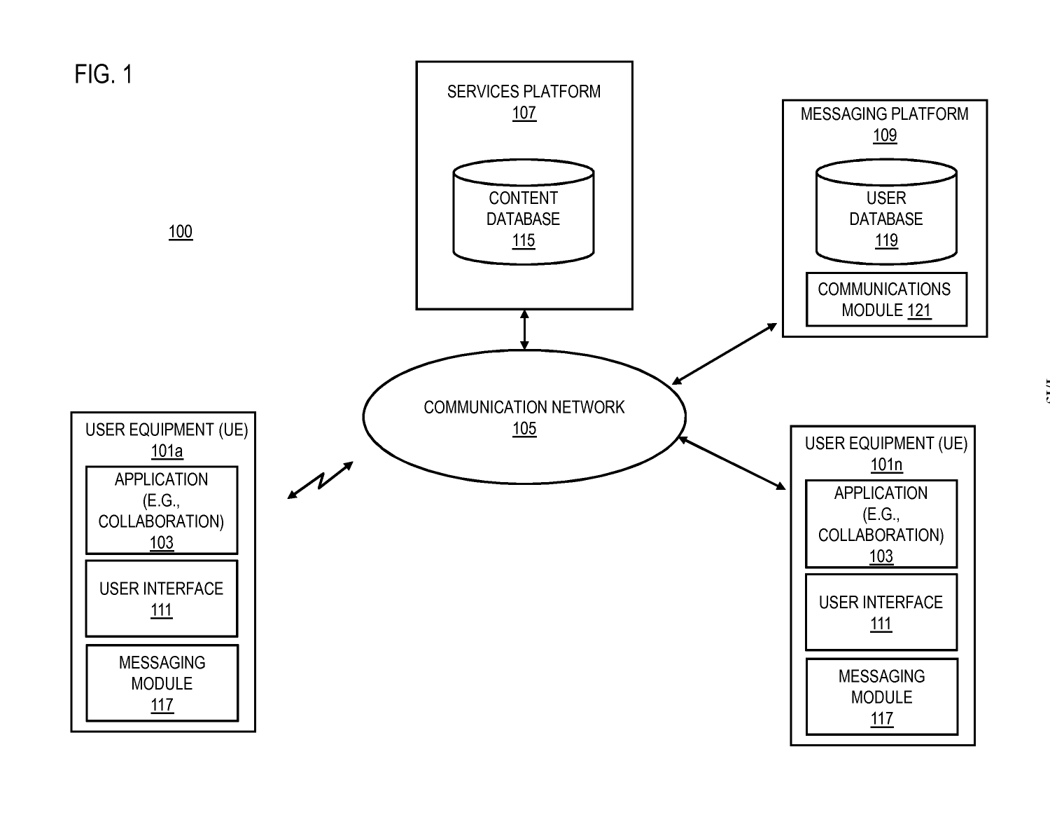

FIG. 1 is a diagram of a system capable of integrating applications and related communication services, according to one embodiment. As noted above, modern users have access to a wide variety of collaborative services and applications. As used herein, the term “collaborative services” refers to services and applications that can be shared or accessed by multiple users or devices at the same time. Typically, the multiple users or devices can then view, edit, review, comment, etc. on the content shared via the applications. Generally, these services and applications include a common display area or canvas that is accessible by the multiple users. In one embodiment, this canvas can be displayed on the device of each respective user. For example, the canvas is used to display a user interface depicting content associated with the collaborative application, such as content related to sharing documents (e.g., word processing documents, presentations, spreadsheets, web pages, etc.), viewing maps, accessing social networking services, sending e-mails, playing games, accessing media sharing services, etc. Although various embodiments are described with respect to collaborative applications, it is contemplated that the approach described herein is applicable to any type of application available on user devices.

Historically, a key feature of a collaborative application is the capability to communicate among the group of users using the application. In this way, the user can, for instance, discuss the content presented in the canvas of the application and collaborate on actions related to the content. By way of example, users of the collaborative application may communicate using messaging options natively available on the users' devices (e.g., native e-mail client, messaging client, etc.) or using messaging functions implemented in the collaborative application itself. One benefit of implementing the messaging functions in the application is that communications related to the content presented in the canvas of the application can be more easily segregated from other general communications received at the device. As a result, collaborative applications generally provide built-in messaging functions and forgo use of the native communication clients available on user devices.

However, as discussed previously, when using collaborative applications, it can be difficult to quickly or efficiently navigate between concurrent or active communication sessions and the shared application canvas (e.g., user interface of the collaborative content). Moreover, it can be particularly difficult to present both a canvas associated with the application and a user interface of the communication sessions and/or messages while working in a limited environment due to screen size limitations associated with user devices. For example, the limited environment (e.g., a smartphone, mobile terminal, etc.), may also not include traditional user interface features such as multiple windows, resizable windows, etc. to facilitate the presentation of the application canvas along with the communication sessions.

To address this problem, a system 100 of FIG. 1 introduces the capability to integrate the display and user interfaces of applications and related communications. More specifically, the system 100 may establish one or more communication sessions (e.g., instant messaging session, etc.) that are associated with the content presented in the canvas of a collaborative application. The system 100 then presents representations (e.g., graphical representations such as chat bubbles) of the communications sessions as elements of the user interface of the application canvas. In one embodiment, the elements representing the communication sessions can then be manipulated on the canvas to control the conduct of the respective communication session (e.g., selected to maximize or minimize the display of the respective communication session, moved on the canvas to join or remove parties to the respective communication session).

In another embodiment, the system 100 enables generating a record of all related or concurrent communication sessions and then associates the record with the content presented in the application canvas. In this way, the record can be attached (e.g., as metadata) or otherwise stored with the content for later review.

In yet another embodiment, the content and associated communication record can be shared among the users of the collaborative application or other authorized or designated users. Moreover, the sharing may be performed according to the respective access rights or policies associated with each user. For example, a particular user may have access rights to only those communications marked as public, whereas private communications may be accessible only by the participants of the private communication session.

As shown in FIG. 1, communication sessions related to, for instance, collaborative applications, can be presented on the user equipment (UEs) 101a-101n as part of or overlaid over the user interfaces or canvases of one or more applications 103 (e.g., a collaboration application, an e-mail application, a social networking service application such as Facebook®, a media application such as photos, music, or video, a map application, etc.). In certain embodiments, an application 103 is a program executing on the UE 101 that, for instance, enables collaboration among multiple users via, at least in part, a common canvas. Further, the application 103 can communicate, via a communication network 105, with a services platform 107 that can provide content and/or other services (e.g., messaging) to the user or multiple users. In certain embodiments, the application 103 can communicate with other UEs 101 directly through the communication network 105 (e.g., via peer-to-peer communications) or via a messaging platform 109 (e.g., via a client-server model). Further, the messaging platform 109 can be integrated into the services platform 107.

When the user activates the application 103, information associated with the application 103 can be presented via a user interface 111 (e.g., an application canvas). The user interface 111 can additionally present messaging associated with a messaging module 113 as user interface elements presented via the user interface 111. The messaging module 113 may be a part of the application 103 or a separate application 103, service, or program. In certain embodiments, a user interface element is a section of the user interface that is associated with one or more sets of features or functions. For example, user interface elements can be representations of content and/or other information (e.g., communication sessions). Further, user interface elements can have associated functions that can be activated by manipulating one or more user interface elements.

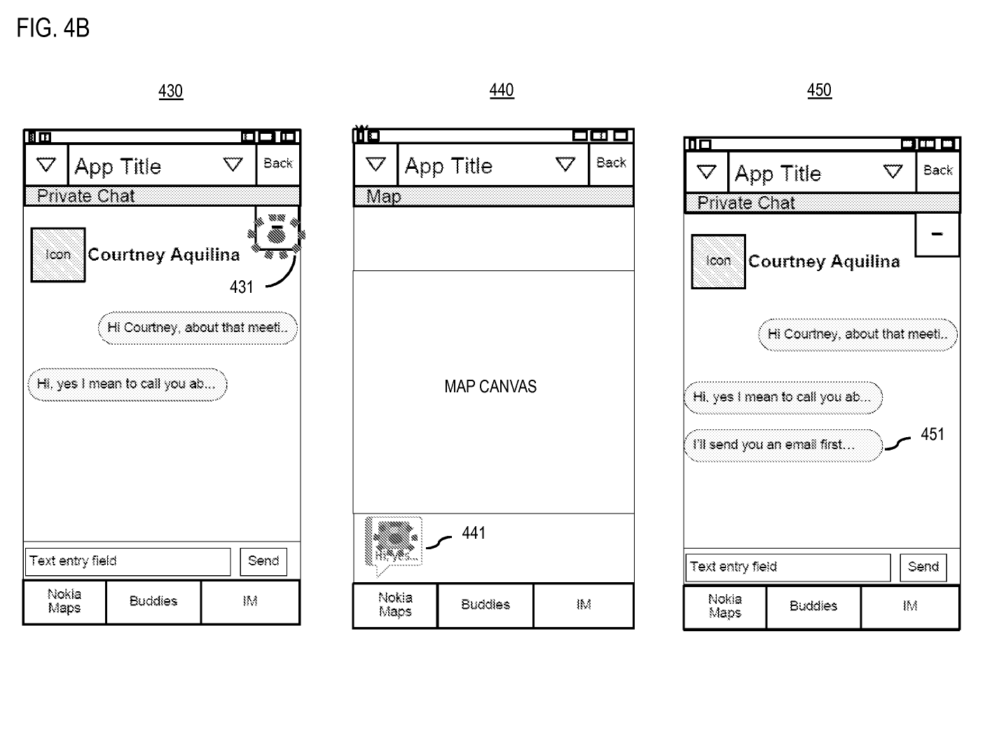

The application 103 can contact the services platform 107 to present content stored in a content database 115. Further, the presented content can be additional information gathered from the services platform 107. This content can be presented via the user interface 111 in another user interface element. This user interface element can be a canvas associated with the application 103. The canvas can include a depiction of the content (e.g., a shared document, image, file, etc.). Further, the content may be modified by one or more UEs 101. For example, in collaborative environment, the content database 115 can include a presentation. In certain scenarios, one or more UEs 101 can modify or control the presentation as the presentation is presented on other UEs 101. In other scenarios, the presentation may be controlled by the services platform 107 or the application 103. Presentation of the canvas can include content associated with the application 103. Further detail associated with the canvas is provided in the descriptions of FIGS. 4A-7C.

A messaging module 117 of the UE 101 can be utilized to control and present communication sessions with users of other UEs 101. The application 103 can receive a request to initiate a communication session (e.g., via the user interface 111 or via a network connection) with another UE 101 or other device connected to the communication network 105. The request can be received from the application 103, applications 103 resident on other UEs 101, input, activation of a document comprising information specifying communication information, or the like. In certain embodiments, a communication session can include transmission of text information, media information (e.g., audio, video, images, etc.), or a combination thereof to be communicated to another party to the communication session. A representation of the communication session may be presented on the user interface 111 as an element of the user interface 111. As such, the user interface element can be manipulated to control the communication session. In certain embodiments, the user interface element includes a chat bubble that can be presented on the user interface in conjunction with the presentation of the application 103 when the user interface element is minimized. In one embodiment, the chat bubble includes, at least in part, a status notification (e.g., notification of new messages, new parties or buddies, etc.), a preview of the communication session (e.g., a scrolling display of the latest message), one or more graphical representations of the parties of the communication session (e.g., an individual or group avatar representing the parties or buddies), or a combination thereof.

Further, more than one communication sessions can be initiated and presented on the user interface 111. In this manner, the communication sessions can be represented as independent chat bubbles. Moreover, the user interface elements associated with the communication sessions may be presented in place of the canvas based on a selection of the chat bubble. An advantage of utilizing chat bubbles is that multiple chat bubbles can be presented on a screen at the same time so that the user can quickly navigate between multiple communication sessions as well as the canvas. As such, the UE 101 can include a means for presenting chat bubbles on a display including the canvas.

Further, the chat bubbles can be manipulated to join messaging parties to one or more communication sessions. For example, the user may select and drag one chat bubble onto another chat bubble to establish a joint communication session with users of UEs 101 of each session. Further, in certain scenarios, the communications histories associated with each session can be combined. As such, the user is presented with the joint communication session including messages and parties of the individual communications and parties that were joined. Further, the joint history can be caused to be transmitted to each UE 101 associated with the joint communication session. In certain scenarios, the messaging platform 109 provides the joint communication history to the UEs 101. In these scenarios, the messaging platform 109 receives communications from each UE 101 and can route communications to associated UEs 101. Information about the UEs 101 associated with the communication session can be stored in a user database 119. To initiate a messaging session with another user, a user of a UE 101 can select one of the users from the user database 119. The user database 119 can include on-line and off-line contact information for each of the UEs 101. Further, a communications module 121 can be utilized to coordinate communication sessions to the UEs 101.

Additionally, as discussed previously, chat bubbles can be used to present a status associated with the associated communication session. For example, when an associated unread communication is received by the messaging module 117, the associated chat bubble can change visual (e.g., color, icon, boldness, etc.) and/or audible presentations (e.g., beep, alarm, etc.). Further, in certain embodiments, the chat bubble can be manipulated by being dragged and dropped into one or more other objects, causing interactions. For example, dropping a chat bubble on a trash icon may initiate the tearing down of the associated communication session. Additionally or alternatively, in certain embodiments, the user may initiate presentation of a list of contacts and drag one of the contacts onto chat bubble to initiate establishment of a communication session. Moreover, the chat bubbles can be moved around portions of the user interface 111 (e.g., overlaid on top of a canvas, other user interface elements, other portions of the user interface 111, etc.). Additionally or alternatively, the chat bubble can be dragged and dropped onto a user interface element associated with sharing (e.g., a billboard, e-mail icon, etc.). When the chat bubble is dropped onto the sharing user interface element, the communication history associated with the chat bubble is caused to be shared via an underlying process of the user interface (e.g., e-mail, billboard, etc.).

Moreover, manipulations of the chat bubble and communication sessions may further be conducted by activating features of the chat bubble element or other user interface elements. For example, a list of users can be brought up by clicking a “buddies” user interface element or by performing a gesture on the chat bubble (e.g., a tap, right click, selecting the chat bubble and selecting an associated key, etc.). Further, the “buddies” user interface element may be part of the application 103 and list contact information of users associated with the canvas (e.g., a presentation to invited guests).

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.).

By way of example, the UE 101, services platform 107, and messaging platform 109 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the services platform 107 and/or messaging platform 109 may interact according to a client-server model with the applications 103, and/or messaging module 117. According to the client-server model, a client process sends a message including a request to a server process, and the server process responds by providing a service (e.g., messaging, e-mail, presentations, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

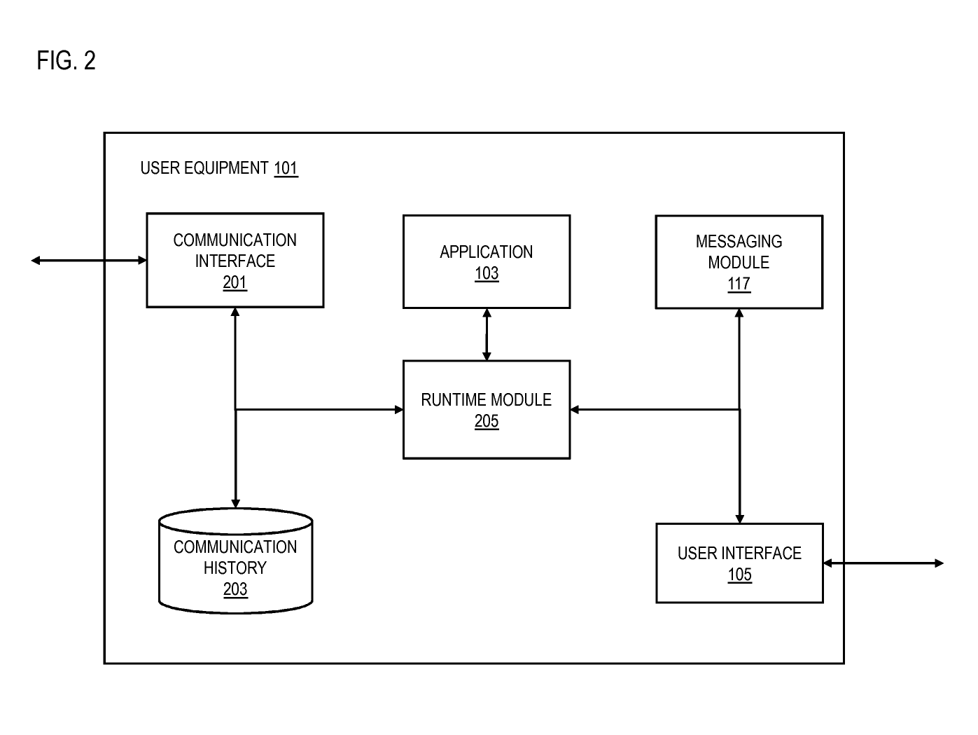

FIG. 2 is a diagram of the components of user equipment configured to integrate applications and related communications, according to one embodiment. By way of example, the UE 101 includes one or more components for presenting communications between users. It is contemplated that the functions of these components may be combined in one or more components or performed by other components of equivalent functionality. In this embodiment, the UE 101 includes a user interface 111 to receive input and provide output at the UE 101, a communication interface 201 to communicate over a network, a messaging module 117 to control communication sessions, a communication history 203 for storing communications between users, and a runtime module 205 to control the execution of applications 103 executing on the UE 101.

The user interface 111 can include various methods of communication. For example, the user interface 111 can have outputs including a visual component (e.g., a screen), an audio component, a physical component (e.g., vibrations), and other methods of communication. User inputs can include a touch-screen interface, a scroll-and-click interface, a button interface, etc. In certain embodiments, the user interface 111 may additionally have a vocal user interface component. As such, a text-to-speech mechanism may be utilized to provide textual information to the user. Further, a speech-to-text mechanism may be utilized to receive vocal input and convert the vocal input into textual input. Moreover, the user interface 111 may be utilized to provide visual output of applications 103 and communications via the messaging module 117. The user interface is additionally detailed in the descriptions of FIGS. 4A-7C.

The communication interface 201 may include multiple means of communication. For example, the communication interface 201 may be able to communicate over SMS, MMS, internet protocol, instant messaging, voice sessions (e.g., via a phone network), or other types of communication protocols. The communication interface 201 can be used by the runtime module 205 and/or messaging module 117 to communicate with other UEs 101, the services platform 107, the messaging platform 109, and other devices. In some examples, the communication interface 201 is used to transmit and receive communication messages to obtain services from the services platform 107.

As noted, the messaging module 117 may be a part of the application 103 or separate from the application 103 (e.g., a plug-in, an associated application, etc.). The messaging module 117 can be utilized to control communications between users (e.g., add buddies, remove buddies, end the session, etc.), initiate communications, initiate sending of communications, receive communications, generate a communication history 203, etc. Further, the runtime module 205 can be used to associate user interface elements manipulated via input with the control of communication sessions via the messaging module 117.

In one embodiment, the messaging module 117 can receive input via the user interface that a user interface element is being manipulated. One such manipulation is a manipulation for combining communication sessions. When a first user interface element associated with a first communication session is manipulated to be added to a second user interface element, the two communication sessions can be joined to include each of the parties of the communication session. Further, parameters can be set so that communications histories from one communication session can be presented on the joint communication session. In certain embodiments, one of the first or second communication sessions is modified to add the additional parties. In other embodiments, a new communication session is created and populated with the parties of the first and second communication session. Moreover, parameters may be set as to how information of the original communication sessions is shared with the other parties. For example, only the original parties may have access to the respective communication histories before the join, or all joined parties may have access to all prior messages, including those occurring before the joining of the communication sessions.

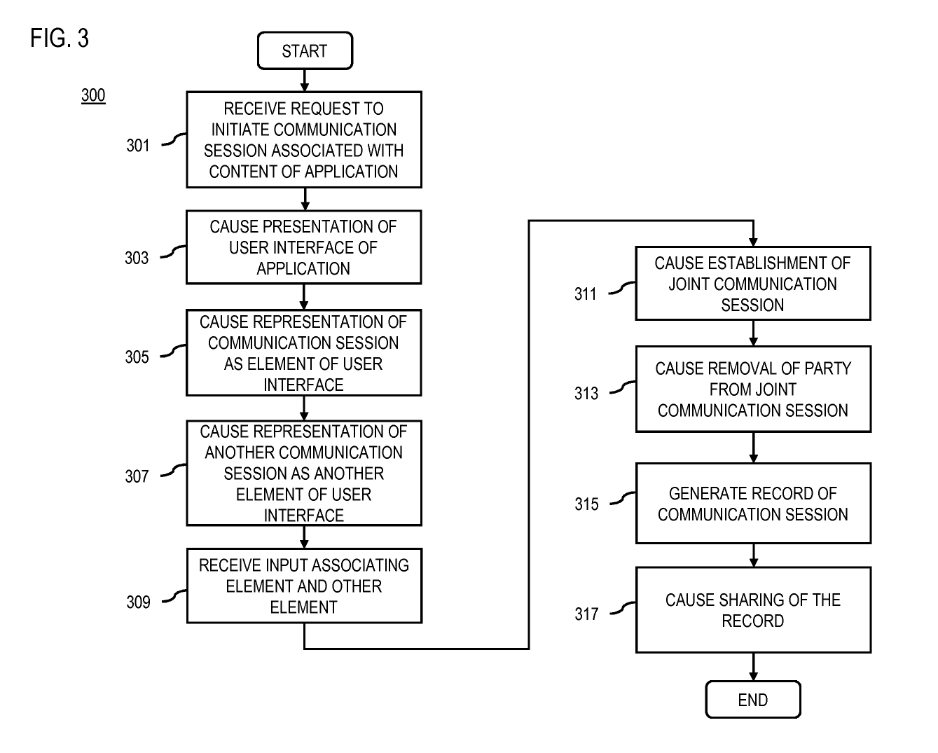

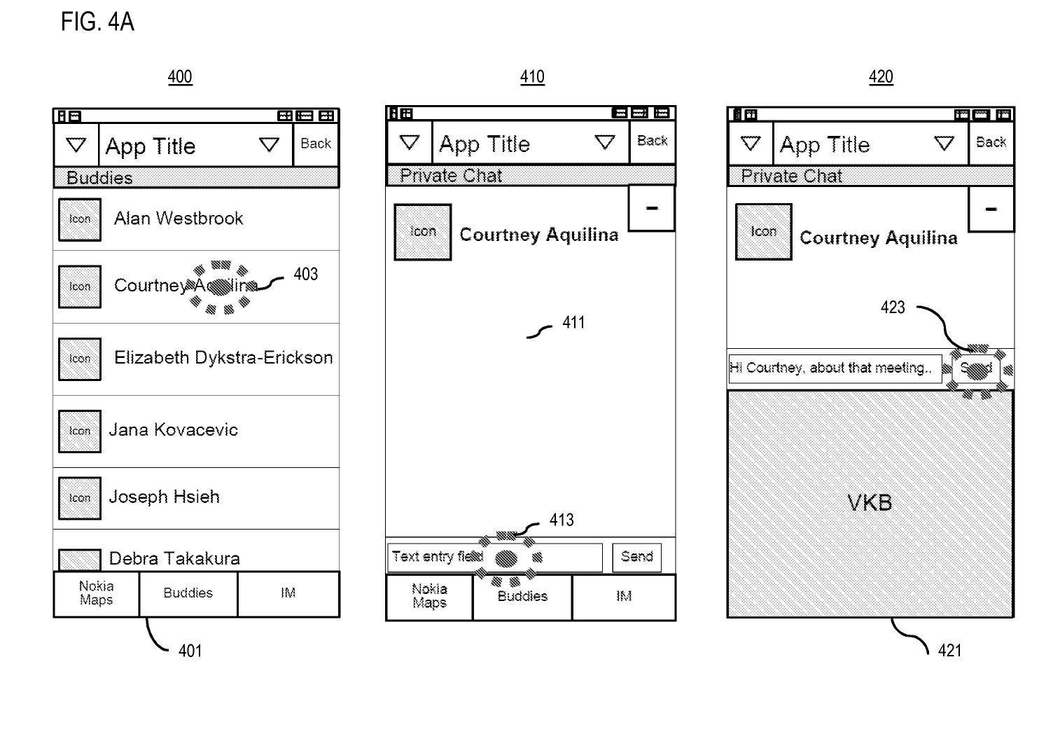

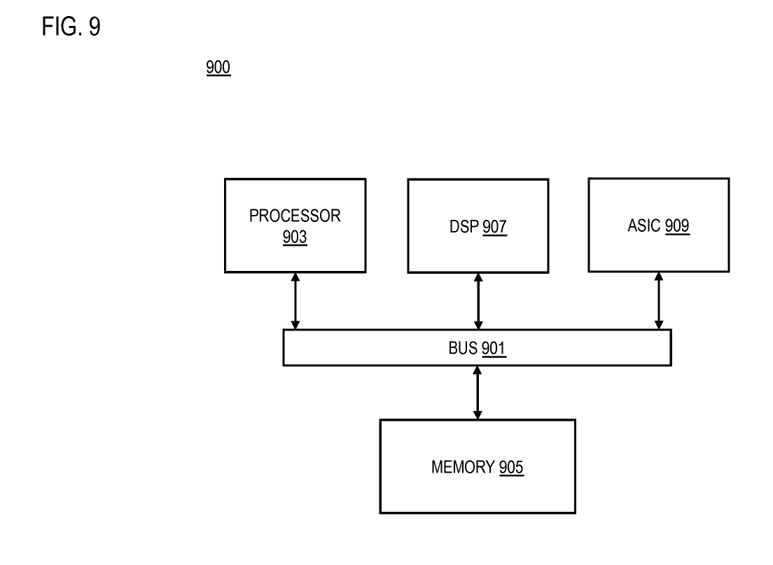

FIG. 3 is a flowchart of a process for integrating applications and related communications, according to one embodiment. In one embodiment, the runtime module 205 and/or messaging module 117 performs the process 300 and is implemented in, for instance, a chip set including a processor and a memory as shown FIG. 9. As such, the messaging module 117 and/or runtime module 205 can provide means for accomplishing various parts of the process 300 as well as means for accomplishing other processes in conjunction with other components of the UE 101. In certain embodiments, parts of the process 300 may be performed by a messaging platform 109 or services platform 107.

At step 301, the runtime module 205 receives a request to initiate a communication session between the UE 101a (e.g., a device) and a second UE 101b. The communication session can be associated with content (e.g., content presented in a canvas) presented by the application 103. For example, the communication session can be conducted among users that have access to the canvas (e.g., access to view, edit, revise, comment, etc.). Further, the request can be initiated by the user of the UE 101 (e.g., via input) or be received from the communication network 105. For example, in certain embodiments, the request is initiated by the application 103 or activation of a document or presentation comprising information that describes communication details (e.g., one or more parties to be associated with the communication session and/or contact information such as e-mail addresses, phone numbers, etc. associated with the respective parties) of one or more users or UEs 101 associated with the communication session. The communication session between the UE 101 a and the second UE 101b is then caused to be initiated by the runtime module 205.

Then, at step 303, the runtime module 205 can cause, at least in part, presentation of a user interface (e.g., a graphical user interface (GUI)) of the application 103 to depict the content. In this manner, data associated with a canvas of the application 103 is presented via the user interface 111. Exemplary user interfaces are detailed in the description of FIGS. 4A-7C.

Next, at step 305, the runtime module 205 causes, at least in part, representation of the communication session as an element of the user interface. In certain embodiments, the element can be a minimized representation of the communication session. In other words, the communication session element is presented when, for instance, a full-screen representation of the communication session is caused to be minimized. Further, the element can include a status notification, a preview of the communication session (e.g., last message), one or more graphical representations of a party to the communication session, etc. Moreover, as noted previously, the element can include a chat bubble that is overlaid on top of the presentation of the user interface or canvas when the full-screen representation of the communication session is minimized. The ability to alternate between the full-screen representation and the minimized element enables the runtime module 205 to approximate the functions of a windows-based user interface even on devices (e.g., certain mobile devices) where such a windows-based interface is not available.

In one embodiment, the manipulation of the element controls the communication session. That is, the manipulation of the element can cause controlling of the UEs 101 party to the communication session, information exchanged in the communication session, establishment of the communication session, tearing down of the communication session, a combination thereof, etc. By way of example, the manipulation of the element (e.g., chat bubble) can include the dragging and dropping (e.g., via a touch screen, via a point and click mechanism, a cursor mechanism, etc.) the element on another user interface element (e.g., another icon representing another function, such as another chat bubble, a trash icon associated with tearing down the session, an icon representing starting a new session, etc.). Further, manipulation of the element may include selecting the user interface element for viewing additional manipulation options (e.g., tearing down a chat session, adding a party to a chat session, sharing a chat session, etc.) via a contextual menu.

At step 307, the runtime module 205 causes, at least in part, representation of another communication session as another element (e.g., a second chat bubble) of the user interface 111. The runtime module 205 can receive input of another request to initiate the other communication session between the UE 101a and a third UE 101c. The runtime module 205 can then utilize the messaging module 117 to initiate the communication session using conventional techniques.

Then, at step 309, the runtime module 205 receives input for associating the element representing the first communication session (e.g., the communication session between the UE 101a and the UE 101b) and the other element representing the second communication session (e.g., the communication session between the UE 101a and the UE 101c). In one embodiment, the association can include the manipulation of the element with respect to the other elements. For example, the element (e.g., first chat bubble) can be dragged and dropped onto the other element (e.g., the second chat bubble). Then, at step 311, the runtime module 205 causes establishment of a joint communication session including the communication session and the other communication session based, at least in part, on the input associating the element and the other element. The joint communication session may include the histories of the communication and the other communication session. In certain embodiments, these histories can be sent to the other UEs 101 involved in the joint communication session directly via the communication interface 201 or via updating a messaging platform 109 associated with the communications. More than one communication session can be joined in this manner and joint communication sessions can be grown by adding two joint communication sessions.

In certain embodiments, at step 313, the runtime module 205 causes, at least in part, removal of a specified UE 101 (e.g., any of the UEs 101a-101c) from the joint communication session based, at least in part, on input. The input can be received specifying the one of the UEs 101 associated with the joint communication session. The input may include manipulating the element associated with the joint communication session or a part of the element (e.g., a user name associated with the specified UE 101) to remove specified UE 101. The specified UE 101 can be selected and dragged out of the joint communication session (e.g., into its own private communication session or into a user interface element, such as a trash icon, associated with removing the UE 101 from a communication session. When the user is removed, the user may be limited in further communications from the joint communication session and/or may lose session history depending on the access rights or policies implemented with respect to the removed user or the user's device.

At step 315, the runtime module 205 generates a record of one or more of the communication sessions (e.g., the communication session, the other communication session, the joint communication session, etc.). The record can be associated with the content (e.g., the parties involved in the communication session can be invited to the presentation of the content). The record can include the communication history of the communication session and may include communication history from previous communication sessions utilized to create the communication session (e.g., a joint communication session). Further, the record can be filtered based on users, time, or other mechanisms. In one embodiment, the runtime module 105 may create a general communication history available to, for instance, all users with access the content presented in the canvas of the application 103 (e.g., public access). This general communication history can then be recorded with the histories of the other communication sessions.

In certain embodiments, the communication histories may be independently designated as public or private. Histories of private communication histories would then be available based on the access rights of users requesting access to the histories. In some embodiments, users without access rights receive no indication that the respective private history exists.

Next, at step 317, the runtime module 205 causes, at least in part, sharing of the record, the content, or a combination thereof. The sharing can be accomplished using a manipulation of the associated user interface element (e.g., by dragging the user interface element to a sharing user interface element such as a billboard). In some embodiments, dragging of communications to the billboard may be disabled to prevent inadvertent disclosure of private communications. In other embodiments, the communication history may be included as metadata associated with the content. In yet another embodiment, the format of the content or its file structure may enable recording of the communication history. For example, presentation file formats may include fields for notes where the communication history can be stored, or word processing files may include comment fields where individual communication messages can be linked to specific portions of the content file.

In one example, the user can drag a chat bubble onto the canvas to share the communications of the chat bubble with other users viewing the canvas. As such, the generated record of the communication session is sent to the application 103 to be presented via the canvas. In certain embodiments, an updated canvas is presented to other users viewing the canvas via a client-server model or via a peer-to-peer model. The updated canvas includes the shared record. As previously noted, the canvas may include a map, a document, a presentation, media such as images, video, audio, etc., a games, or the like. The presentation of the shared record can be dependent on the type of canvas. For example, the shared record may be presented as part of a presentation or as an overlay on a map.

In one embodiment, the application 103 includes a general communication session (e.g., a billboard) that is separate from the communication session. A billboard may be a messaging interface associated with the application 103 that allows each of the viewers of the canvas permission to view messages displayed in the messaging interface. In certain embodiments, the billboard posts crawling text that displays the latest message(s) posted in the general communication. Crawling or scrolling text can be advantageous when the display size of the UE 101 is limited because more information can be presented on the display. The general communication session can be public, that is, can be presented to every UE 101 that has access to a particular presentation canvas associated with the application 103. In contrast, user requested communication sessions may be private and accessible only to those UEs 101 that are party to the session or that are otherwise authorized (e.g., administrator or superuser access).

FIGS. 4A-7C are diagrams of user interfaces utilized in the processes of FIG. 3, according to various embodiments. User interfaces 400, 410, 420, 430, 440, 450 of FIGS. 4A-4B show the creation of a private communication session in a GUI. User interface 400 includes a list of parties (e.g., users available to communicate with, such as users that have access to a canvas of the GUI) that can be selected to initiate a private communication session. The list can be presented by selecting a “buddies” user interface element 401. The users can then select one or more of the buddies (e.g., the second party 403) to initiate the communication session. If more than one user is selected, a joint communication session can be created. User interface 410 shows options available to the user of the UE 101 to communicate via the initiated chat session 411. The user can select a text field 413 to add text to send textual communication to the other party. The text field 413 can initiate an option for a virtual key board 421 of user interface 420 to be presented to enter text. Additionally or alternatively, a key based input mechanism may be utilized to enter text. When the user completes the user's message, the user can send 423 the message to the other party involved in the communication session.

User interface 430 depicts an exemplary communication session between the user and the other party. This communication session can be minimized or otherwise transformed by selecting a portion 431 of the user interface 430. As such, a user interface element 441 of user interface 440 can be presented to represent the communication session. In this example, the user interface element 441 includes a chat bubble. The chat bubble can have an indicator (e.g., shading on the left section of the icon) to indicate that new communications are available. Moreover, an icon, image, or other visual indicator associated with the other party can be used as part of the user interface element 441 display. Further, a portion of the latest communication may be previewed as part of the user interface element 441. This portion can include crawling or scrolling text of the latest communication message. In certain embodiments, when the user interface element 441 is selected, a representation 451 of the communication session is displayed.

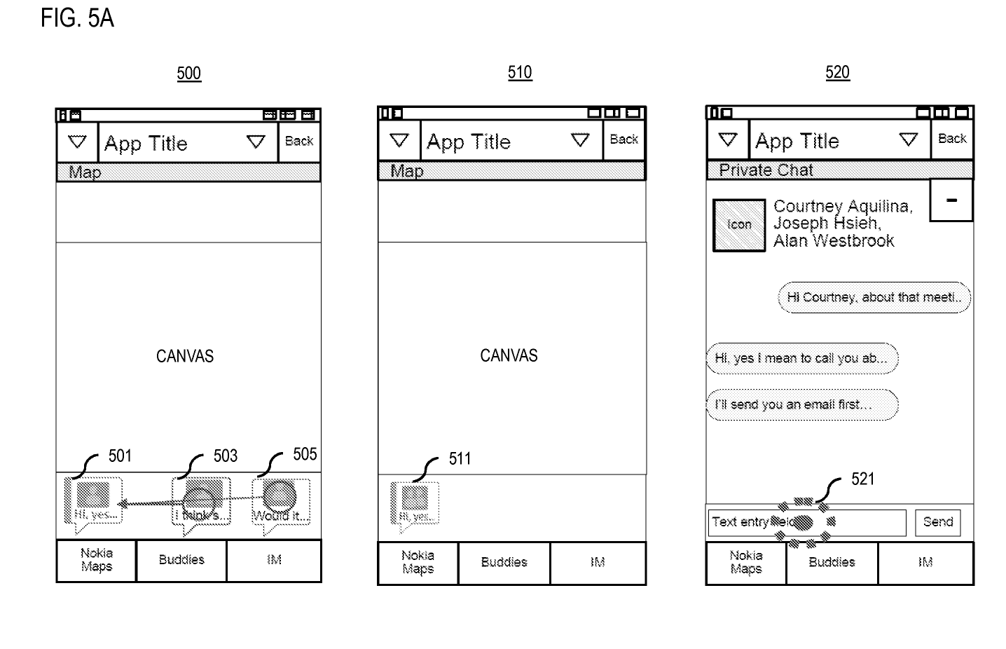

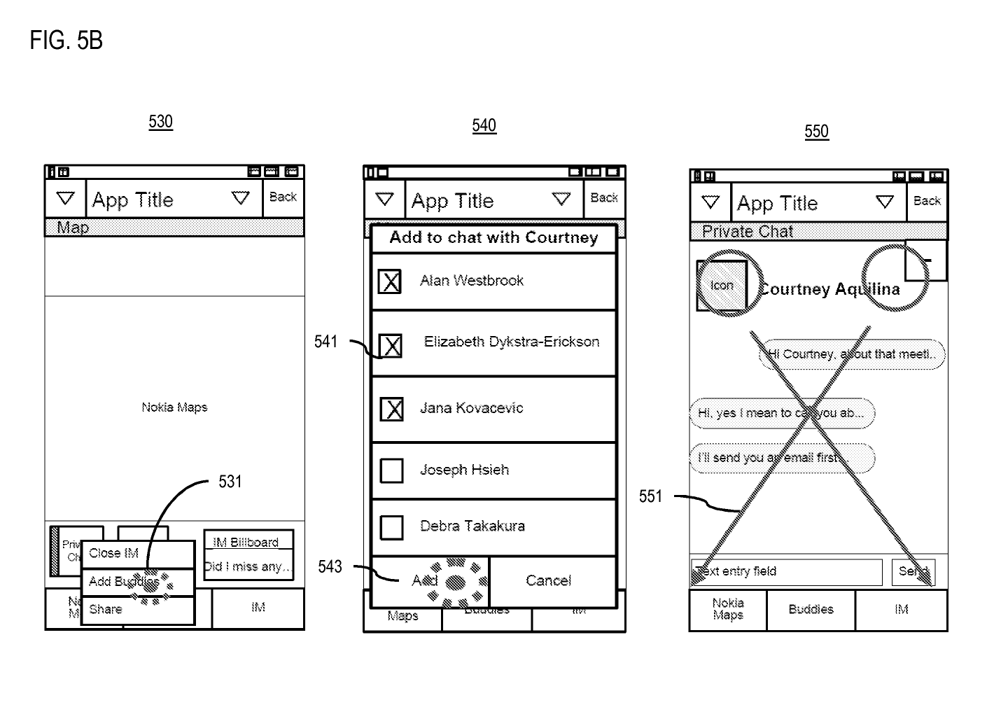

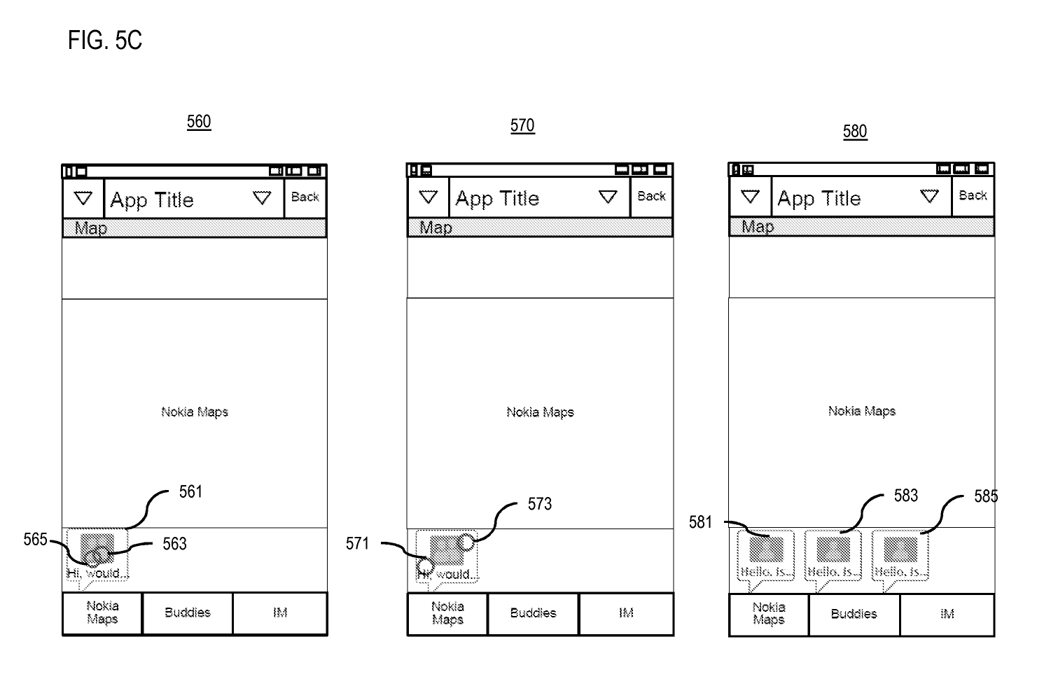

User interfaces 500, 510, 520 of FIG. 5A show manipulations of user interface elements 501, 503, 505 (e.g., chat bubbles), according to one embodiment. In this embodiment, the user interface elements 503 and 505 are combined (e.g., via drag and drop) with user interface element 501. User interface 510 shows the combination of the chat bubbles into a user interface element 511 representing a joint chat. The representation of the joint chat can be associated with icons or other visual indicators associated with the parties of the joint chat. The joint chat can be a joint communication session including each of the individual communication sessions represented in user interface 500. User interface 520 presents a view of the joint communication session with three parties other than the user of the UE 101. Additional parties may be added in a similar fashion. When the user enters input into the text field 521, each of the parties can see the message.

FIG. 5B shows user interfaces 530, 540, 550 that provide for an alternative mode of adding buddies to a private chat between two or more UEs 101 as well as terminating a represented communication session. A gesture (e.g., long touch, right click, etc.) can be performed on the user interface element associated with the private chat. An option menu can be presented with an add buddy option 531. When this option 531 is selected, a menu 541 of available parties to add to the private chat is presented. The user can check off which buddies the user wishes to add and can select an add option 543. Then, these parties can become participants in a joint private chat. User interface 550 shows a view of an ongoing chat session with another user. When the user desires to close the communication session, the user can perform a gesture 551 (e.g., an X across the user interface 550) to terminate the communication session. Processes can be used to close the communication session. Then, in certain scenarios, another chat session is presented to the user, the canvas is displayed, or another process provides presentation via the user interface 550.

FIG. 5C presents user interfaces 560, 570, 580 associated with the splitting of joint communication sessions into individual communication sessions. As such a gesture (e.g., move apart, pinch away, etc.) can be performed on a group chat user interface element 561. For this gesture, on a touch screen user interface, the user can select two points 563, 565 on the group chat user interface element 561 and move the points away from each other as shown in user interface 570. Different threshold limits on how far apart the points 571, 573 need to be separated to be considered a gesture for splitting joint communication sessions can be set. Once the gesture is performed, individual communication session user interface elements 581, 583, 585 are presented to the user.

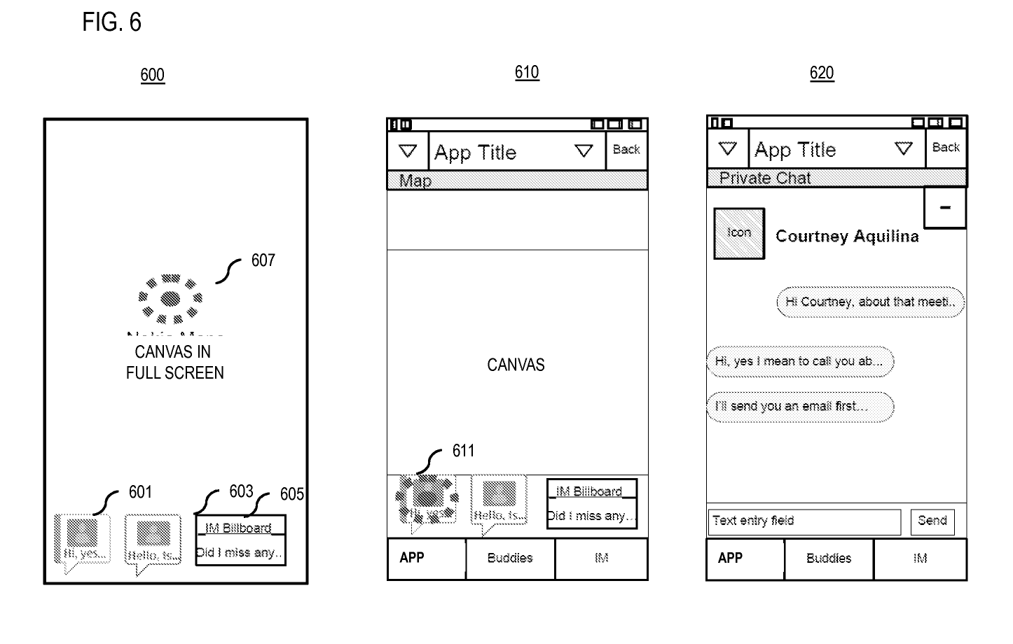

User interfaces 600, 610, 620 of FIG. 6A show view options associated with the content (e.g., canvas) of the application 103. User interface 600 shows the canvas presented as a full view. In full view, tool bars and title information may be removed from the presentation. In this embodiment, the user interface includes the canvas and user interface element representations 601, 603, 605 of communications. Communications associated with user interface elements 601 and 603 may be private chats between the user and other parties. The billboard messaging representation 605 can be a public messaging service that anyone who has access to the canvas can view and/or participate in sending messages via. In some embodiments, since the billboard is public, private chats cannot be combined into the billboard. In other embodiments, if a user moves one of the user interface elements 601, 603 representing private communications onto the billboard, the communications history of the chat session is provided for the billboard. Moreover, when a portion 607 of the full screen view is selected, another view of user interface 610 showing the canvas as well as additional functions (e.g., buttons and label information) is presented. If the user selects a user interface element 611 associated with a private communication, the private communication can be presented on user interface 620.

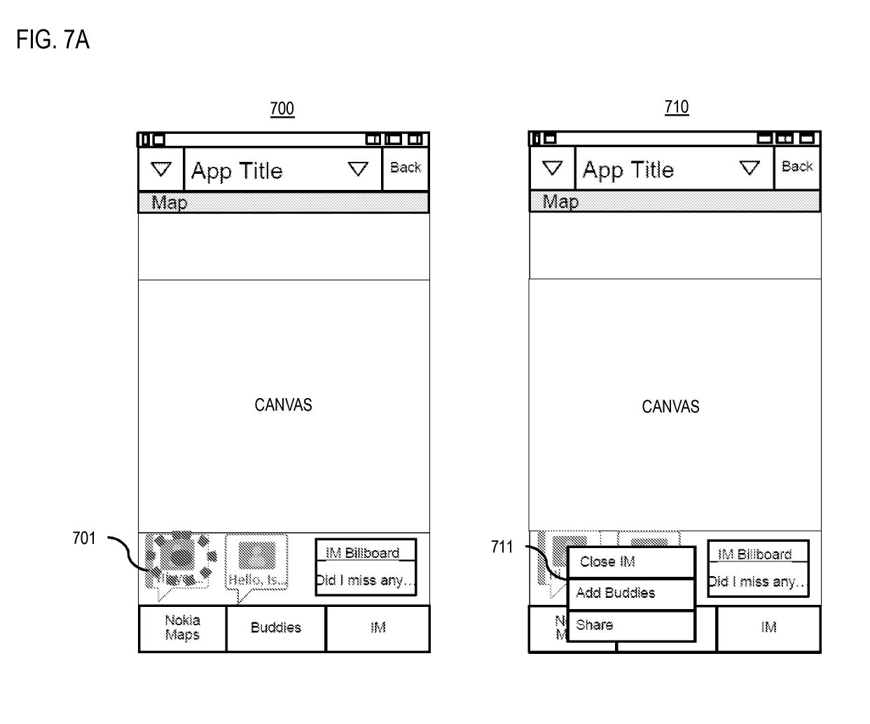

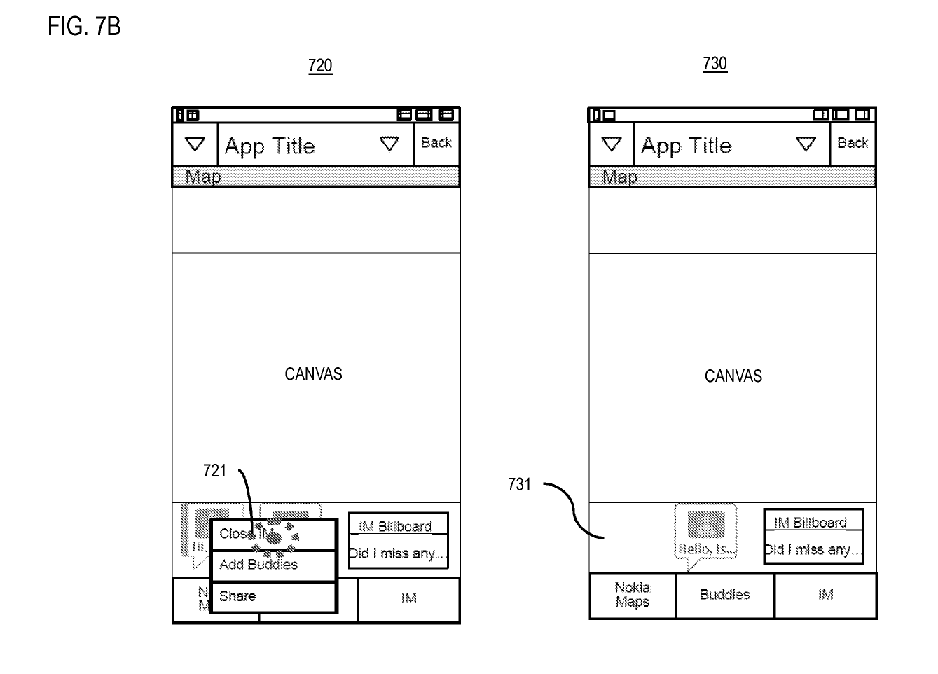

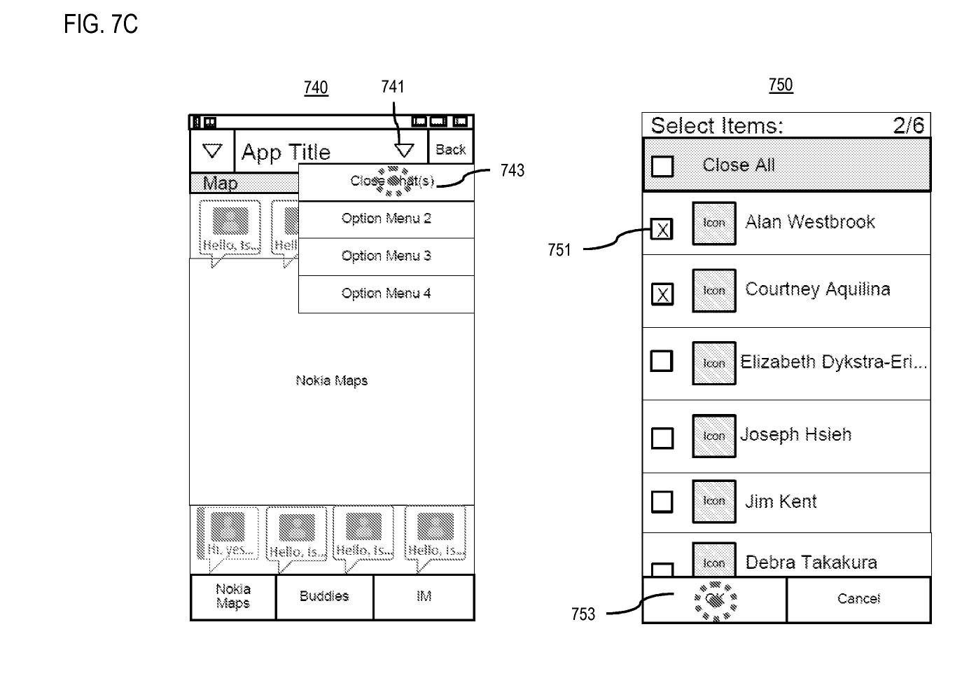

User interface 700, 710, 720, 730, 740, 750 of FIGS. 7A-7C display options for terminating communication sessions using one or more gestures starting from a user interface element 701. A gesture (e.g., long press, right click, left click, button press, etc.) is performed on the user interface element 701 or while the user interface element 701 is selected. Then, an option menu 711 of user interface 710 is presented to the user. As shown, the option menu 711 allows the user to close the communication session, add a buddy to the communication session, or share the communication session. The user can select the close communication session option 721 to initiate the termination of the communication session. Then, a blank area 731 available to other user interface elements can be presented to the user in place of the chat bubble associated with the terminated communication session.

As shown in FIG. 7C, user interface 740 can provide access to general menus that can control the communication sessions displayed to the user via option menus. The options may additionally include a close communication session option 743. When the close communication session option 743 is selected, a menu of open communication sessions can be presented to the user. The user can select 751 communication sessions that the user desires to terminate and terminate a group of communication sessions by selecting a confirmation option 753. The communication sessions can include individual communication sessions as well as group communication sessions (not shown).

With the above recited approaches, communications between users can be represented as a user interface element. The user interface element can be manipulated to control associated communication sessions. In this manner, more options can be provided to the user. This can be particularly beneficial in small screen environments where user interface space is limited. Moreover, the above features allow the user to quickly and efficiently navigate both communication sessions as well as associated applications. Particularly, the manipulations allow the user to quickly join two communication sessions together with a single gesture. This can allow for processor time and power savings because multiple gestures need not be wasted to join the communication sessions.

The processes described herein for integrating applications and related communications may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

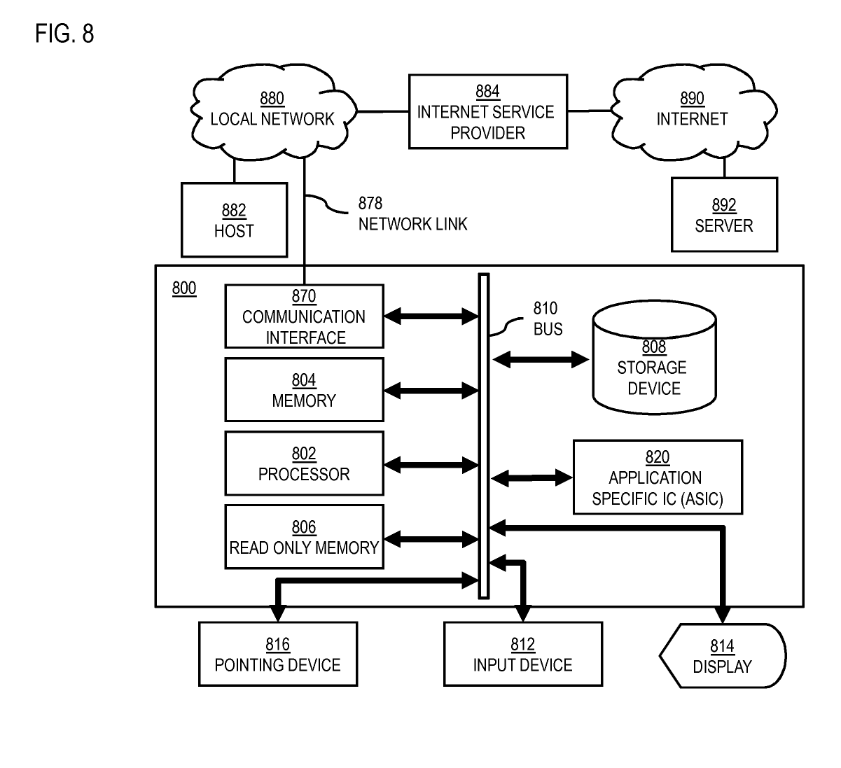

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to integrate applications and related communications as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of integrating applications and related communications.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to integrating applications and related communications. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for integrating applications and related communications. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for integrating applications and related communications, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to integrate applications and related communications as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of services. Chip set or chip 900, or a portion thereof, constitutes a means for performing one or more steps of integrating applications and related communications.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to integrate applications and related communications. The memory 905 also stores the data associated with or generated by the execution of the inventive steps.

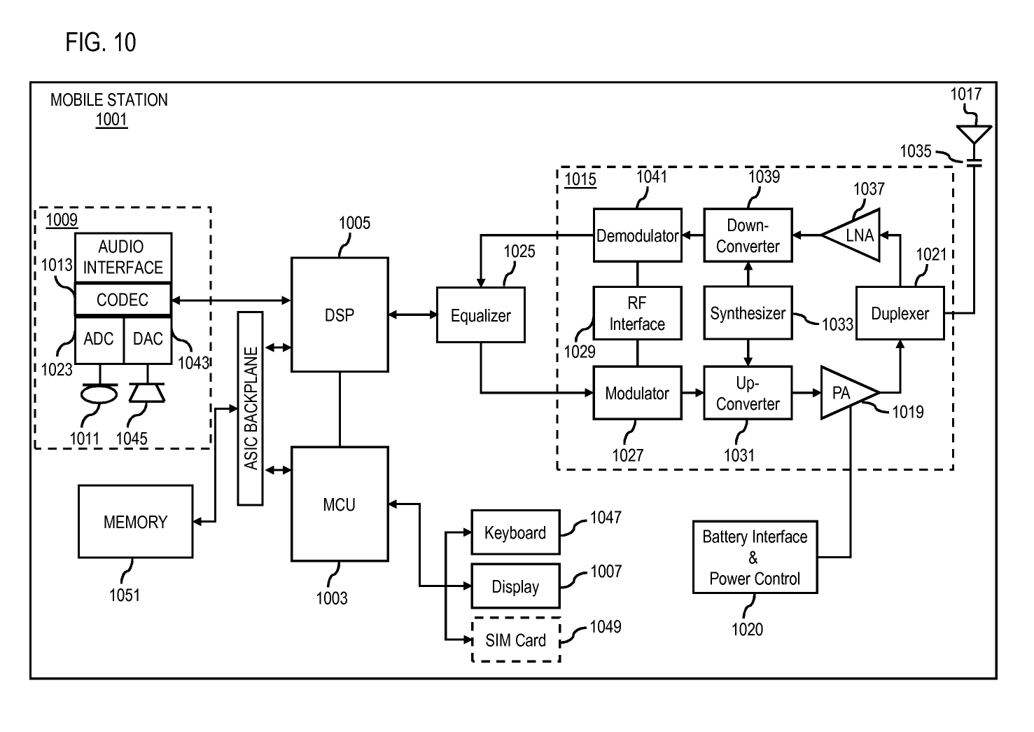

FIG. 10 is a diagram of exemplary components of a mobile terminal (e.g., handset) for communications, which is capable of operating in the system of FIG. 1, according to one embodiment. In some embodiments, mobile terminal 1000, or a portion thereof, constitutes a means for performing one or more steps of integrating applications and related communications. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of integrating applications and related communications. The display 10 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to integrate applications and related communications. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-25. (canceled)

26. A method comprising facilitating a processing of and/or processing (1) data and/or (2) information and/or (3) at least one signal, the (1) data and/or (2) information and/or (3) at least one signal based, at least in part, on the following:
a determining to initiate a communication session between a first device and a second device, the communication session associated with content presented by an application;
a determining to cause, at least in part, presentation of a user interface of the application to depict the content; and
a determining to cause, at least in part, representation of the communication session as an element of the user interface,
wherein manipulation of the element controls the communication session.

27. A method of claim 26, wherein the controlling of the communication session includes controlling devices party to the communication session, information exchanged in the communication session, establishment of the communication session, tearing down of the communication session, or a combination thereof.

28. A method of claim 26, the (1) data and/or (2) information and/or (3) at least one signal further based, at least in part, on the following:
a determining to initiate another communication session between the first device and a third device;
a determining to cause, at least in part, representation of the another communication session as another element of the user interface.

29. A method of claim 28, wherein the manipulation of the element to control the communication session comprises:
receiving an input for associating the element and the another element; and
causing, at least in part, establishing of a joint communication session including the communication session and the another communication session based, at least in part, on the input.

30. A method of claim 29, wherein the joint communication session includes the first device, the second device, and the third device, the (1) data and/or (2) information and/or (3) at least one signal further based, at least in part, on the following:
another input for specifying at least one of the first device, second device, third device, or combination thereof; and
a determining to cause, at least in part, removal of the specified device from the joint communication session based, at least in part, on the another input.

31. A method of claim 26, the (1) data and/or (2) information and/or (3) at least one signal further based, at least in part, on the following:
a generating a record of the communication session;
a determining to cause, at least in part, associating the record with the content; and
a determining to cause, at least in part, sharing of the record, the content, or combination thereof.

32. A method of claim 26, wherein the element is a minimized representation of the communication session and includes a status notification, a preview of the communication session, one or more graphical representations of a party to the communication session, or a combination thereof.

33. A method of claim 26, wherein the application includes a general communication session that is separate from the communication session, and wherein the general communication session is public and the communication session is private.

34. A method of claim 26, wherein the user interface includes an application canvas and the element is a bubble overlaid on the application canvas.

35. An apparatus comprising:
at least one processor; and
at least one memory including computer program code for one or more programs,
the at least one memory and the computer program code configured to, with the at least one processor, cause the apparatus to perform at least the following,
determine to initiate a communication session between a first device and a second device, the communication session associated with content presented by an application;
cause, at least in part, presentation of a user interface of the application to depict the content; and
cause, at least in part, representation of the communication session as an element of the user interface,
wherein manipulation of the element controls the communication session.

36. An apparatus of claim 35, wherein the controlling of the communication session includes controlling devices party to the communication session, information exchanged in the communication session, establishment of the communication session, tearing down of the communication session, or a combination thereof.

37. An apparatus of any of claim 35, wherein the apparatus is further caused, at least in part, to:
determine to initiate another communication session between the first device and a third device;
cause, at least in part, representation of the another communication session as another element of the user interface.

38. An apparatus of claim 37, wherein the manipulation of the element to control the communication session causes the apparatus to be further caused, at least in part, to:
receive an input for associating the element and the another element; and
cause, at least in part, establishing of a joint communication session including the communication session and the another communication session based, at least in part, on the input.

39. An apparatus of claim 38, wherein the joint communication session includes the first device, the second device, and the third device, and wherein the apparatus is further caused, at least in part, to:
receive another input for specifying at least one of the first device, second device, third device, or combination thereof; and
cause, at least in part, removal of the specified device from the joint communication session based, at least in part, on the another input.

40. An apparatus of claim 35, wherein the apparatus is further caused, at least in part, to:
generate a record of the communication session;
cause, at least in part, associate the record with the content; and
cause, at least in part, sharing of the record, the content, or combination thereof.

41. An apparatus of claim 35, wherein the element is a minimized representation of the communication session and includes a status notification, a preview of the communication session, one or more graphical representations of a party to the communication session, or a combination thereof.

42. An apparatus of claim 35, wherein the application includes a general communication session that is separate from the communication session, and wherein the general communication session is public and the communication session is private.

43. An apparatus of claim 35, wherein the user interface includes an application canvas and the element is a bubble overlaid on the application canvas.

44. A computer-readable storage medium carrying one or more sequences of one or more instructions which, when executed by one or more processors, cause an apparatus to at least part to perform the following:
determining to initiate a communication session between a first device and a second device, the communication session associated with content presented by an application;
determining to cause, at least in part, presentation of a user interface of the application to depict the content; and
determining to cause, at least in part, representation of the communication session as an element of the user interface,
wherein manipulation of the element controls the communication session.

45. A computer-readable storage medium of claim 44, wherein the controlling of the communication session includes controlling devices party to the communication session, information exchanged in the communication session, establishment of the communication session, tearing down of the communication session, or a combination thereof.
